(19) United States
(12) Patent Application Publication
(10) Pub. No.: US 2005/0251435 A1
(43) Pub. Date: Nov. 10, 2005

(54) Systems and methods for managing resources

(76) Inventors: Michael J. Paolella, E. Wareham, MA (US); Janice M. Yu, Potomac, MD (US); Larry Anderson, Coto De Caza, CA (US); Jon Keller, Burnsville, MN (US); Ronald E. Henderson, Manassas, VA (US)

Correspondence Address: FINNEGAN, HENDERSON, FARABOW,;GARRETT & DUNNER, L.L.P., 55 Cambridge Parkway, Cambridge, MA, 02142-1292, US

(21) Appl. No.: 10/955,411

(22) Filed: Sep. 30, 2004

Related U.S. Application Data
(60) Provisional application No. 60/507,933, filed on Oct. 3, 2003.

(51) Int. Cl. G06F 17/60

(52) U.S. Cl. 705/8

(57) ABSTRACT

Systems and methods for managing human resources are provided. In one embodiment, a resource management system includes a network resource management server including at least one database containing data related to human resources and at least one resource management system application. The resource management system may further include business rules that, when applied to the human resource data, generates an action. Access to the system can be provided to both an employer and employee by telephone or electronically for efficient and standardized processing of a leave request.

### CROSS-REFERENCE TO A RELATED APPLICATION

This application claims the benefit of U.S. Provisional Application No. 60/507,933, filed Oct. 3, 2003.

### FIELD OF THE INVENTION

The invention relates to the field of management, and more particularly, to systems and methods for managing human resources.

### BACKGROUND OF THE INVENTION

Human resources are important assets that organizations rely on to deliver consistent excellent service to their customers. Human resources, when unavailable because of sickness, vacation, or other reasons, affect an organization's performance negatively. For example, unscheduled absences create several problems for organizations, such as increasing overtime expenditure. This is because available employees might have to put hours beyond their schedule to compensate for the unavailable employees' time.

Often, unscheduled absences result from unclear expectations of employees. Clear expectations with respect to a schedule that an employee must follow have to be communicated. Subsequently, effective tools have to be in place to monitor compliance with the schedule. Moreover, without proper leave tracking, an organization may be unable to effectively monitor and improve a situation involving a chronically absent employee. Additionally, lack of proper management systems may also create missed opportunities for correcting absenteeism. In cases of non-compliance, processes have to be implemented to reinforce the adherence of an employee to his or her work schedule such that the employer could deliver consistent quality results to its customers.

Further, organizations must also comply with various federal, state, and local regulations, such as the Family and Medical Leave Act, in approving or denying an employee's request for leave. Without proper tracking and management of leave, regulatory compliance can cause severe inconvenience for both the employers and the employees.

Current systems and methods for managing resources, such as human resources, are inadequate to address these human resources management problems. Accordingly, there is a need for systems and methods for managing resources to effectively address human resources management problems.

### SUMMARY OF THE INVENTION

In accordance with the invention, systems and methods for managing human resources are provided. In one embodiment, a method for managing human resources includes applying at least one business rule to human resources management data. The method further includes automatically triggering at least one action based on a result of the application of at least one business rule to the human resources management data.

In another embodiment, a system for managing human resources includes a means for applying at least one business rule to human resources management data. The system further includes means for automatically triggering at least one action based on a result of the application of at least one business rule to the human resources management data.

In another embodiment, a method for providing interactive leave processing is provided. The method includes receiving a call from an employee to request leave for a period of time. The method further includes prompting the employee to select a category of leave. The method further includes, based on the selected category, prompting the employee for additional information concerning the leave-type. The method further includes providing a leave-request confirmation number to the employee. The method can further include generating an authorization form documenting the leave request. Finally, the method can include communicating the leave request to a supervisor of that employee.

It is to be understood that both the foregoing general description and the following detailed description are exemplary and explanatory only and are not restrictive of the invention, as claimed.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

### BRIEF DESCRIPTION OF THE DRAWINGS

The accompanying drawings, which are incorporated in and constitute a part of this specification, illustrate several embodiments of the invention and together with the description, serve to explain the principles of the invention.

In the drawings:

FIG. 1 is a block diagram illustrating an exemplary system environment for managing human resources, consistent with systems and methods of the present invention;

FIG. 2 is a block diagram illustrating an exemplary resource management system, consistent with systems and methods of the present invention;

FIG. 3 is a flow diagram illustrating exemplary processes that may be performed, consistent with systems and methods of the present invention;

FIG. 4 is a flow diagram illustrating exemplary employee leave processing, consistent with systems and methods of the present invention;

FIG. 5 is a screen shot illustrating exemplary employee leave processing, consistent with systems and methods of the present invention;

FIG. 6 is another screen shot illustrating exemplary employee leave processing, consistent with systems and methods of the present invention;

FIG. 7 is another screen shot illustrating exemplary employee leave processing, consistent with systems and methods of the present invention;

FIG. 8 is another screen shot illustrating exemplary employee leave processing, consistent with systems and methods of the present invention;

FIG. 9 is another screen shot illustrating exemplary employee leave processing, consistent with systems and methods of the present invention;

FIG. 10 is a flow diagram illustrating exemplary employee schedule management, consistent with systems and methods of the present invention;

FIG. 11 is a screen shot illustrating exemplary employee schedule management, consistent with systems and methods of the present invention;

FIG. 12 is another screen shot illustrating exemplary employee schedule management, consistent with systems and methods of the present invention;

FIG. 13 is another screen shot illustrating exemplary employee schedule management, consistent with systems and methods of the present invention;

FIG. 14 is a flow diagram illustrating exemplary report processing, consistent with systems and methods of the present invention;

FIG. 15 is a screen shot illustrating exemplary report processing, consistent with systems and methods of the present invention;

FIG. 16 is a flow diagram illustrating exemplary family leave processing and administrative action processing, consistent with systems and methods of the present invention;

FIG. 17 is a flow diagram illustrating exemplary human resources management consistent with systems and methods of the present invention;

FIG. 18 is a block diagram illustrating exemplary interactive voice communication with the exemplary human resources management system consistent with systems and methods of the present invention;

FIG. 19 is a flow diagram illustrating exemplary call processing, consistent with systems and methods of the present invention;

FIG. 20 is a screen shot illustrating exemplary call processing, consistent with systems and methods of the present invention;

FIG. 21 is another screen shot illustrating exemplary call processing, consistent with systems and methods of the present invention;

FIG. 22 is yet another screen shot illustrating exemplary call processing, consistent with systems and methods of the present invention;

FIG. 23 is a screen shot illustrating exemplary call processing by a call center agent, consistent with systems and methods of the present invention;

FIG. 24 is another screen shot illustrating exemplary call processing by a call center agent, consistent with systems and methods of the present invention;

FIG. 25 is yet another screen shot illustrating exemplary call processing by a call center agent, consistent with systems and methods of the present invention;

FIG. 26 is still a further screen shot illustrating exemplary call processing by a call center agent, consistent with systems and methods of the present invention;

FIG. 27 is even still another screen shot illustrating exemplary call processing by a call center agent, consistent with systems and methods of the present invention;

FIG. 28 is another screen shot illustrating exemplary call processing by a call center agent, consistent with systems and methods of the present invention;

FIG. 29 is yet another screen shot illustrating exemplary call processing by a call center agent, consistent with systems and methods of the present invention;

FIG. 30 is still another screen shot illustrating exemplary call processing by a call center agent, consistent with systems and methods of the present invention;

FIG. 31 is another screen shot illustrating exemplary call processing by a call center agent, consistent with systems and methods of the present invention;

FIG. 32 is still another screen shot illustrating exemplary call processing by a call center agent, consistent with systems and methods of the present invention;

FIG. 33 is even still another screen shot illustrating exemplary call processing by a call center agent, consistent with systems and methods of the present invention;

FIG. 34 is yet another screen shot illustrating exemplary call processing by a call center agent, consistent with systems and methods of the present invention;

FIG. 35 is another screen shot illustrating exemplary call processing by a call center agent, consistent with systems and methods of the present invention;

FIG. 36 is still another screen shot illustrating exemplary call processing by a call center agent, consistent with systems and methods of the present invention;

FIG. 37 is even still another screen shot illustrating exemplary call processing by a call center agent, consistent with systems and methods of the present invention; and

FIG. 38 is yet another screen shot illustrating exemplary call processing by a call center agent, consistent with systems and methods of the present invention.

### DESCRIPTION OF THE EMBODIMENTS

Reference will now be made in detail to the present embodiments (exemplary embodiments) of the invention, examples of which are illustrated in the accompanying drawings. Wherever possible, the same reference numbers will be used throughout the drawings to refer to the same or like parts.

The resource management system of the present invention preferably includes a plurality of user terminals connected via a network, such as a local area network (LAN) and/or the Internet, to a resource management server. The resource management server preferably includes at least one database containing data related to human resources, such as employee leave data. The resource management server may further include at least one resource management system application (RMS application), which application may include various software modules that, when executed by a computer, provide various functions associated with the resource management system. The resource management system may further include various business rules that can be invoked manually, or may be triggered automatically, to generate at least one action based on a result of the application of at least one business rule to the human resources data. A manager or a supervisor may access the resource management system in a secure fashion to add, edit, or delete the human resources data.

The features of the present invention may be implemented in various system or network environments to provide automated computational tools to facilitate management of human resources. Such environments and applications may be specially constructed for performing the various processes and operations of the invention, or they may include a general-purpose computer or computing platform selectively activated or reconfigured by program code to provide the necessary functions. The processes disclosed herein are not inherently related to any particular computer or other apparatus, and may be implemented by a suitable combination of hardware, software, and/or firmware. For example, various general-purpose machines may be used with programs written in accordance with the teachings of the invention, or it may be more convenient to construct a specialized apparatus or system to perform the required methods and techniques. The present invention also relates to computer readable media that include program instruction or program code for performing various computer-implemented operations based on the methods and processes of the invention. The media and program instructions may be those specially designed and constructed for the purposes of the invention, or they may be of the kind well known and available to those skilled in the computer software arts. Examples of program instructions include both machine code, such as the type produced by a compiler, and files containing a high level code that can be executed by the computer using an interpreter.

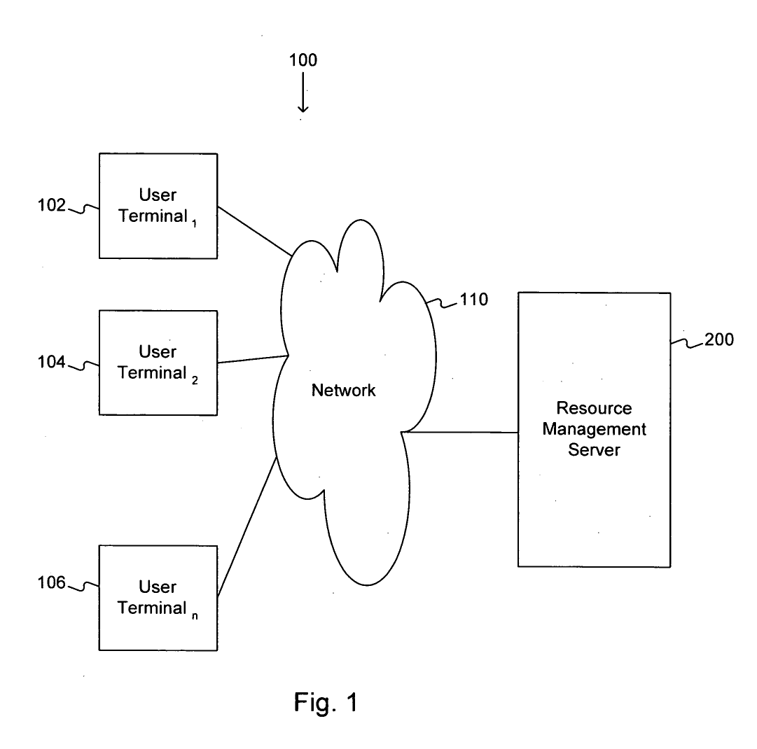

FIG. 1 illustrates an exemplary system environment 100 for managing human resources, consistent with the present invention. A user terminal₁ 102, a user terminal₂ 104, and a user terminalₙ 106 may be connected via a network 110 to a resource management server 200. One skilled in the art will appreciate that any number of user terminals may be connected via any number of networks to any number of resource management servers. Network 110 may be any appropriate type of network, such as, for example, an internal network (intranet) or a public network (e.g. the Internet). Additionally, network 110 may utilize any suitable type of network protocol.

User terminal₁ 102 may be any appropriate type of a user terminal, such as, for example, a user computer executing a web browser type program, such as Microsoft's Internet Explorer or a Netscape browser. Accordingly, user terminal₁ 102 may include a processor, memory, storage, and an interface for connecting to network 110. In an exemplary embodiment, a user, such as a manager or supervisor, using user terminal₁ 102 with a web browser type program, may connect via network 110 to resource management server 200. After logging into the resource management system, the user may then navigate through the web pages to the desired services (e.g., leave tracking). For example, a user may select to connect to network 110 using a web browser, such as with Internet Explorer, by entering a Uniform Resource Locator (URL) identifying resource management server 200 (e.g., www.usps.com).

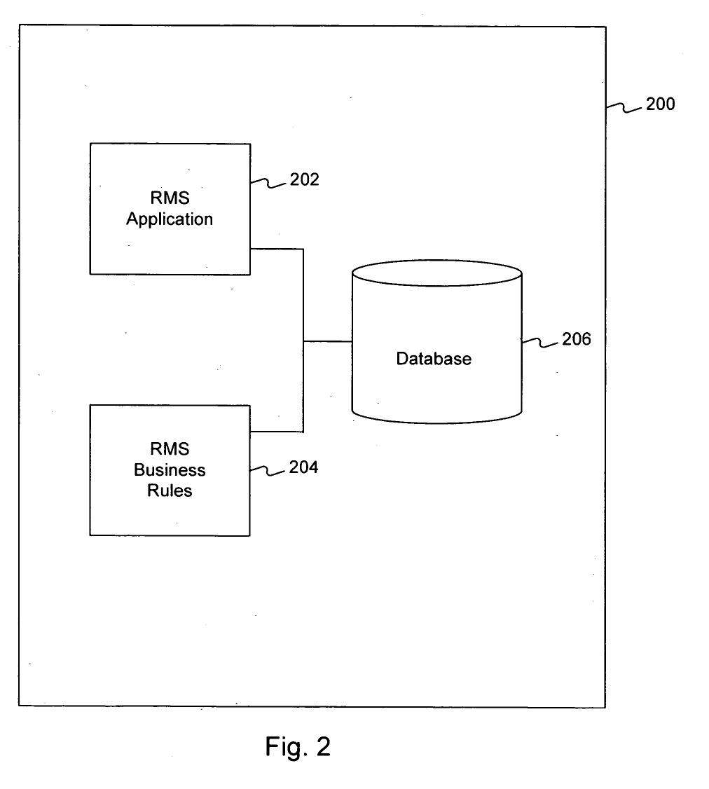

FIG. 2 illustrates an exemplary resource management server 200, which may include an RMS application 202, an RMS business rules component 204, and a database 206. RMS application 202 may include software modules which, when executed by a processor, may perform various functions associated with resource management server 200. One skilled in the art will appreciate that RMS application 202 may be implemented using any suitable programming language and environment. One skilled in the art will also appreciate that components of the RMS application may reside on resource management server 200, other servers or computers, or on user terminals, such as user terminal₁ 102. RMS business rules component 204 may include software modules encapsulating business rules which, when used in combination with human resources data stored, for example, in database 206, may produce at least one result. One skilled in the art will appreciate that RMS business rules may reside on resource management server 200, other servers or computers, or on user terminals, such as user terminal₁ 102. Database 206 may include a wide variety of data relevant to managing human resources. Such data, for example, may include employee leave data, employee work schedule data, and employee administrative action data. Employee leave data may further include annual leave data, annual medical leave data, and annual family leave data. By way of a non-limiting example, any data elements that could be accessed via screens or monitor displays or printed in reports may be stored in database 206. One skilled in the art will appreciate that database 206 is exemplary and relevant data may be stored in other databases, which may be located on other computers, servers, or user terminals.

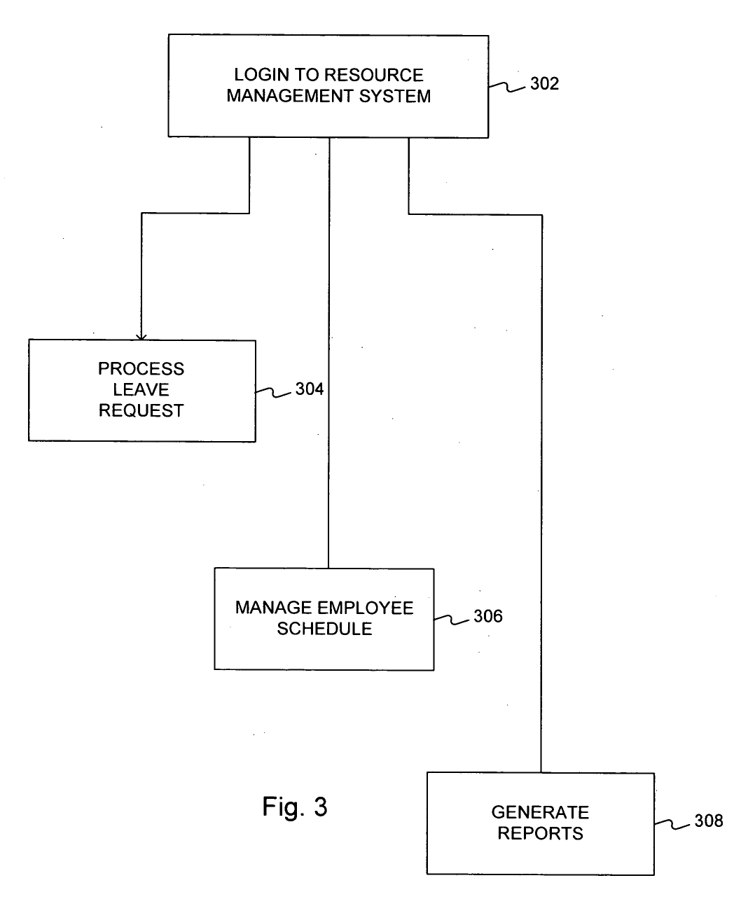

FIG. 3 is a flow diagram illustrating some of the exemplary processes that may be performed, consistent with the present invention. Thus, for example, after logging into the resource management system (step 302), a supervisor may process a leave request (step 304), manage an employee schedule (step 306), or generate reports (step 308).

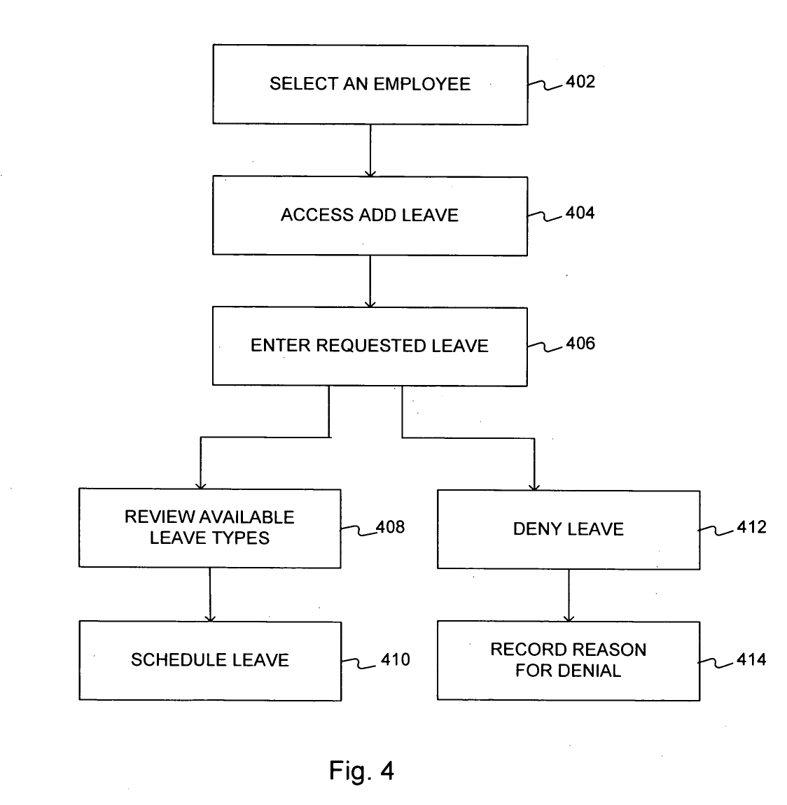

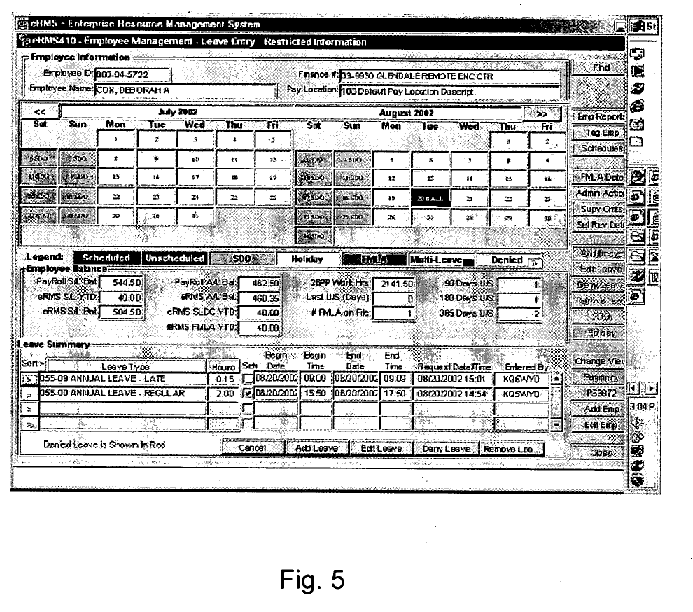

In one embodiment, after logging into the resource management system, the supervisor may be presented with a main menu that includes employee management as an option. Employee management may include leave processing, as shown in FIG. 4. Once the supervisor selects the employee management option, the supervisor may be presented with a screen, as shown in FIG. 5. Next, the supervisor may select the employee requiring leave processing (step 402 of FIG. 4). The supervisor may select the employee in any number of ways, including for example, entering the employee's identification (ID) number in the “Employee ID” field, which may be, for example, the employee's social security number. By way of a non-limiting example, other ways of selecting an employee include searching for the employee in an employee database based on criteria such as the employee's name, title, department, or work location.

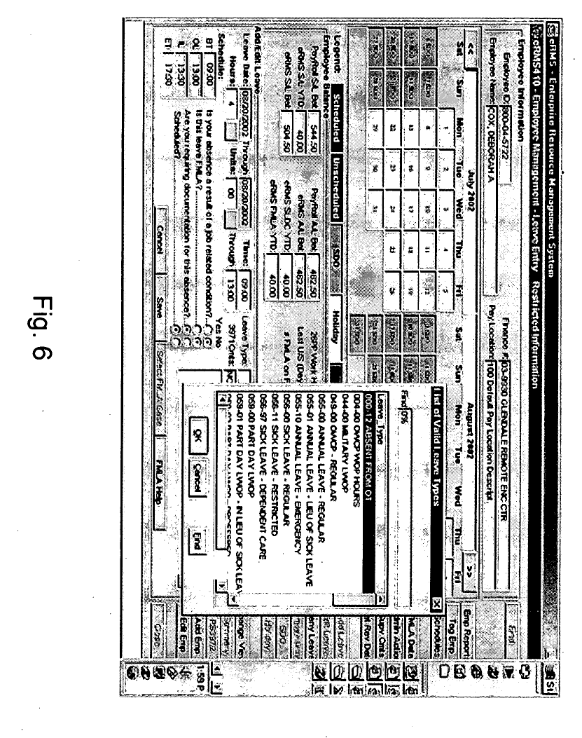

Having selected the employee, the supervisor may access the add leave function of the system (step 404). FIG. 6 illustrates an exemplary screen that may be displayed once the supervisor accesses the add leave function. Next, the supervisor may enter requested leave (step 406). This step may involve entering the employee's start and end dates for the requested leave. Then, the supervisor may review available leave types (step 408), as shown in screen depicted in FIG. 6. By way of non-limiting examples, leave types can include annual leave, sick leave, or leave without pay. Leave types may have associated codes, which may be stored in database 206, such that RMS application 202 may keep track of available leave for each employee in various available leave type categories.

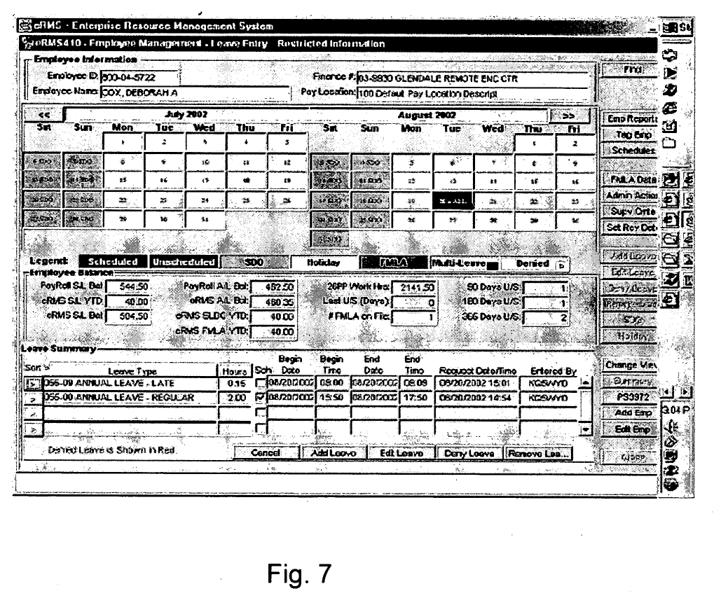

Next, the supervisor may schedule leave (step 410). As shown in FIG. 6, this process may also include adding leave related information to the resource management system, such as whether the leave is a result of a job related condition, whether the leave is covered under the Family Medical Leave Act, and/or whether the leave requires documentation, such as a doctor's note. Further, as shown in FIG. 7, the supervisor may display the leave summary for the selected employee at any time during this process.

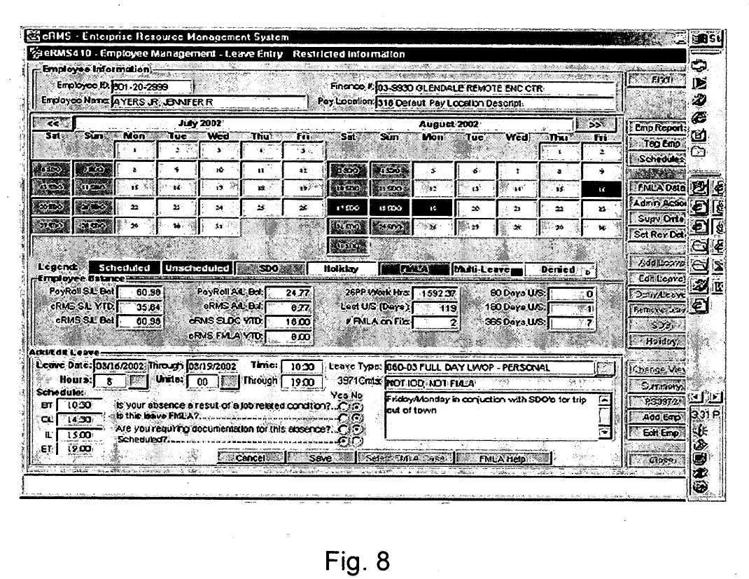

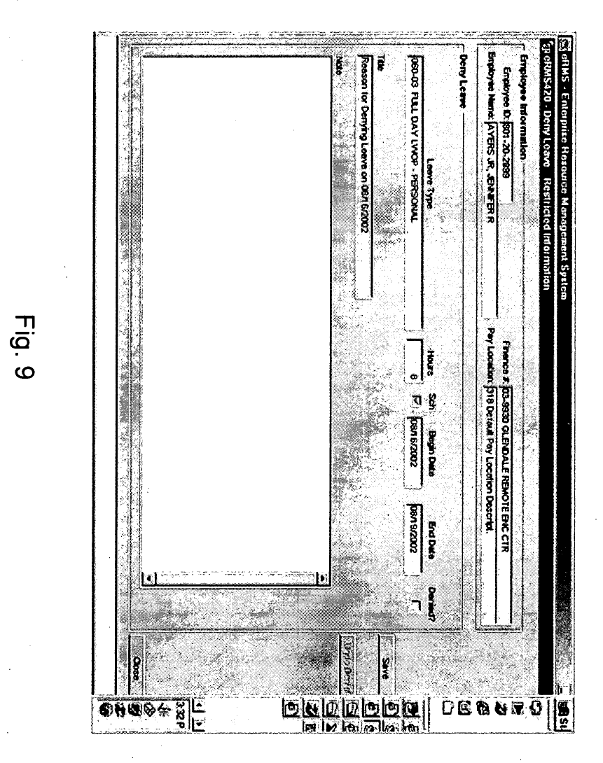

Referring back to FIG. 4, the supervisor may deny an employee's leave request (step 412). FIG. 8 shows an exemplary screen that may be displayed to the supervisor for the deny leave process. As shown in FIG. 8, the leave request may be entered into the system, even though the supervisor has elected to deny the leave. In one embodiment, leave denial may be based on the resource management system's tracking of the employee's accrued leave time and automatic generation of a denial based on a violation of a business rule (204 of FIG. 2). For example, a business rule may be established to compare the employee's available or unused leave time with the requested leave time to determine if the request can be approved. Or, a business rule may be established to deny a leave request if that leave would amount to an employee's total accumulated leave surpassing a predetermined limit, such as for that month or year. In any case, the supervisor may then record a reason for the denial of the leave (step 414). FIG. 9 illustrates an exemplary screen that may be displayed to the supervisor for entering the reason for denial.

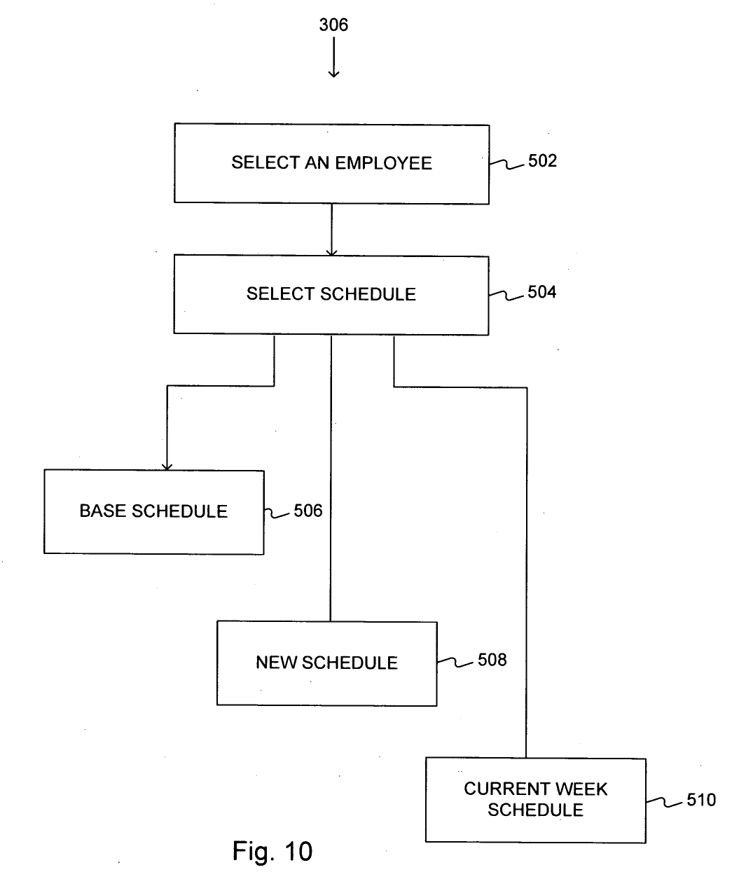

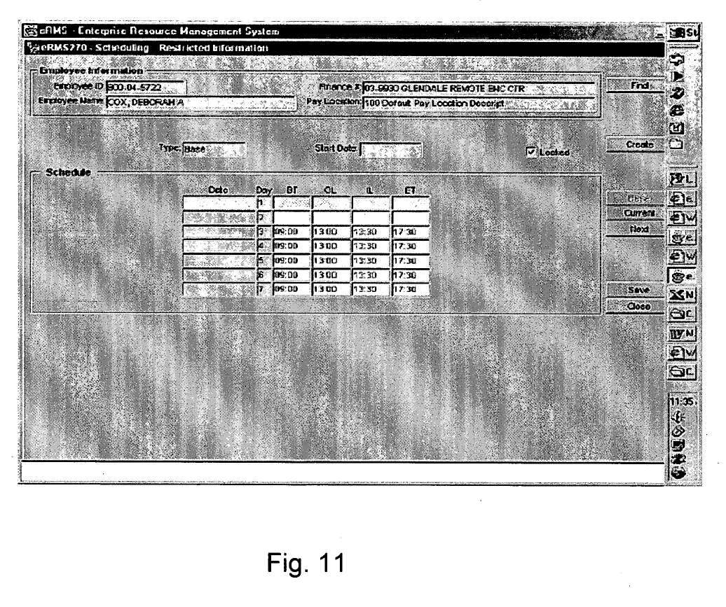

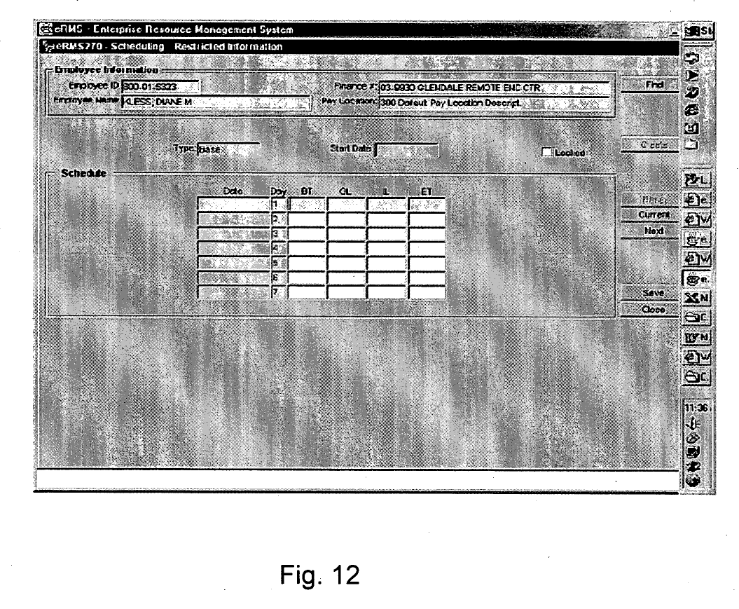

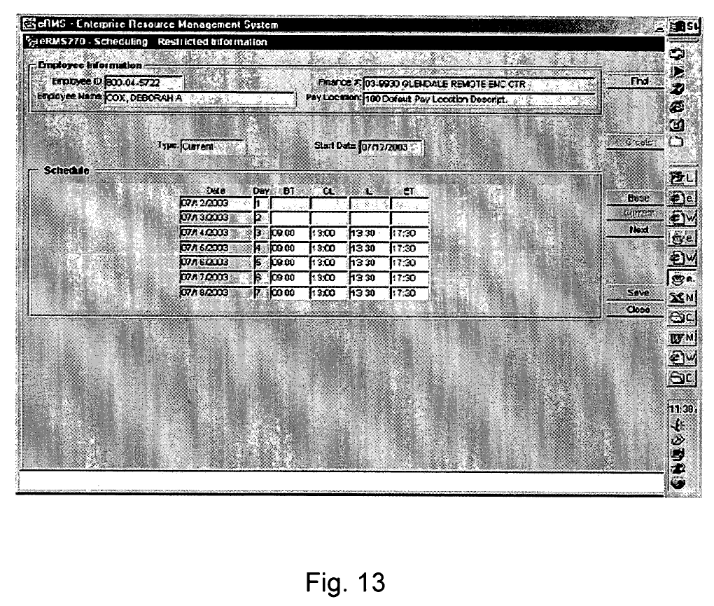

FIG. 10 shows a flow diagram illustrating exemplary employee schedule management consistent with the present invention. Schedule management may include selecting an employee (step 502). As discussed earlier, with respect to FIG. 4, a supervisor may select an employee in various ways. Next, the supervisor may select from one of many work schedules (step 504). In one embodiment, the supervisor may select or click on a schedules button in the employee management window (for example, the screen shown in FIG. 5). In response, the resource management system may display the screen shown in FIG. 11 on the user terminal being used by the supervisor. If the employee has an existing base schedule, then the system may display the employee's base schedule (step 506). However, if no base schedule exists for the employee (for example, the employee is a new employee), then the supervisor may select or click the create button on the screen shown in FIG. 11 to create a new schedule (step 508). In response, the resource management system may display the screen shown in FIG. 12. The supervisor may then populate various fields displayed on the screen to create a base schedule for the employee. Further, the supervisor may also display the selected employee's current week schedule (step 510), as shown in FIG. 13. One skilled in the art will appreciate that these screen displays are merely exemplary and other user interfaces may also be used to accomplish schedule management, for example.

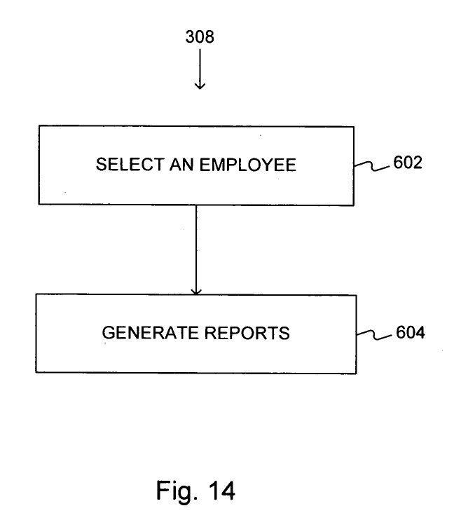

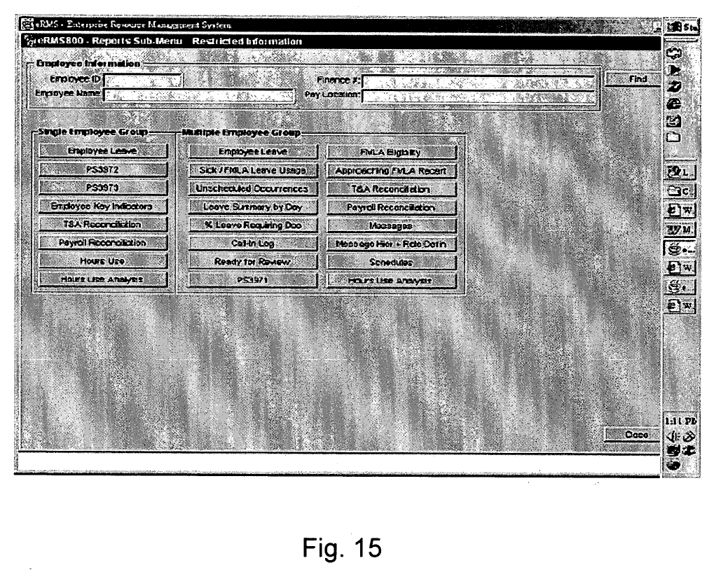

FIG. 14 shows a flow diagram illustrating exemplary report processing, consistent with systems and methods of the present invention. As shown in FIG. 14, after selecting an employee (step 602), the supervisor may generate reports concerning the employee(s) (step 604). Reports may relate to all employees, groups of employees, or individual employees. By way of a non-limiting example, FIG. 15 shows a screen for selecting reports that may be generated, consistent with the present invention. Exemplary reports include employee leave reports (daily and average numbers), key leave information reports, such as sick and annual leave balances, and reconciliation reports (e.g., discrepancies between time entries and payroll data). Employee reports can be generated for a single employee or multiple employees based on employee data such as, for example, job title, department, work location, or employment date. Reports can also be generated using criteria such as data ranges and/or leave type for individuals or all employees.

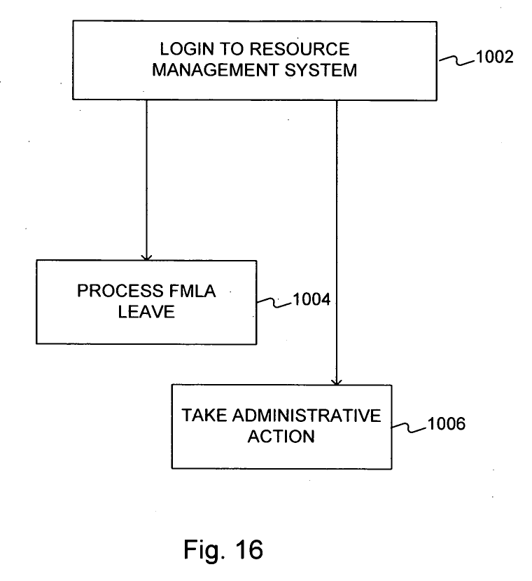

FIG. 16 is a flow diagram illustrating exemplary family medical leave processing and administrative action processing, consistent with the present invention. After logging into the resource management system (1002), a supervisor may process a Family and Medical Leave Act (FMLA) leave request (step 1004) or take administrative action (step 1006) regarding the request. FMLA leave processing may include accessing the resource management system to obtain data to help the supervisor determine whether the employee requesting leave qualifies under the FMLA statute and then processing the leave request accordingly. Such data can include, for example, the date, duration, frequency, and reason for the leave (i.e., condition code, category code and disposition of any employee's family and medical leave). Exemplary types of reasons for the leave can include the birth of a child, adoption or foster care, serious health issues related to a child, spouse or parent, or the serious health issue of the employee that would require overnight hospitalization, incapacity of a predetermined duration due to medical appointments, treatment or medication, pregnancy, chronic conditions causing periodic incapacity, permanent or long-term incapacity due to a condition for which treatment may not be effective (e.g., terminal illness), or a condition that will result in incapacity of a predetermined duration in the absence of treatment. If there is insufficient information to make a determination, such as would be the case where the employee has not yet provided documentation, then the information can be saved and the status of the request deemed pending until the documentation is provided. Once the FMLA data for each request has been entered and saved, the system may then allow tracking of all the FMLA leave taken. Reports of all FMLA leave for a single individual or for all employees can be generated in the manner previously described.

Administrative actions may relate to leave compliance or other human resource issues, such as, for example, persistent tardiness. Administrative action processing may include recording the date and nature of the violation, and description of the action and further ensuring compliance with the rule(s), whose violation may have resulted in the supervisor taking the administrative action. Examples of such actions that may be taken include doing nothing (i.e., no action) or taking a corrective administrative action. For example, the supervisor may indicate whether the employee needs to see the supervisor or whether the employee needs to take corrective action (i.e., prompt attendance in the future). Data corresponding to administrative actions, including the date and nature of the violation(s) and the description of the administrative actions, may be stored in database 206 of FIG. 2. If appropriate, the administrative action processing may also include contacting the employee's supervisor and/or labor representative. For instance, an electronic message may be submitted to the employee's supervisor and/or labor representative notifying him or her of the alleged violation. Comments from the supervisor and/or the labor representative may be solicited in response to the administrative action processing, and those comments may also be stored in the database for future reference and/or further processing.

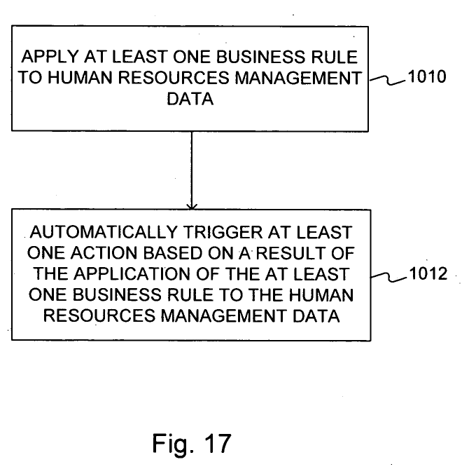

FIG. 17 is a flow chart illustrating exemplary human resources management consistent with the present invention. Upon invocation of this process by the supervisor or upon automatic invocation (e.g., periodic invocation or an event based invocation) RMS application 202 may apply at least one business rule (e.g., RMS business rules 204) to human resources management data stored in database 206 (step 1010). The exemplary process may further include automatically triggering at least one action based on a result of the application of at least one business rule to the human resources management data (step 1012). Business rules may relate to when the resource management system may escalate a process to a higher authority in a chain of management. Thus, for example, in one embodiment, an escalation wait time parameter may be stored in database 206. The escalation wait time parameter may specify, in days, for example, the number of days after which an automatic message (e.g., an email message) will be sent to someone higher up in a chain of management. For example, when a supervisor fails to respond to a time-sensitive task such as a “Review and Respond” task, a message may be sent to the supervisor's manager after the escalation wait timer has expired. RMS application 202 may monitor a timer value and compare it to the escalation wait time parameter periodically. RMS application 202 may then send an appropriate message to the supervisor's manager when the timer value exceeds the escalation wait timer parameter.

Another business rule may relate to automatically scheduling an attendance review for an employee. Thus, RMS application 202 (FIG. 2) may process different business rules related to employee attendance review. Data corresponding to such rules, for example, the number of unscheduled absences that an employee may have within a certain time-period, may be stored in database 206. One exemplary rule may provide invocation of attendance review when the number of unscheduled absences exceed three occurrences in a 90-day period. RMS application 202 may monitor compliance with this rule periodically (e.g., every day, every week, etc.) and upon detecting a violation of the rule automatically trigger an attendance review message for the supervisor of the non-complying employee. One skilled in the art will appreciate that the functionality corresponding to RMS application 202 and RMS business rules 204 may be combined or distributed in any suitable fashion. Moreover, the business rules discussed above are merely exemplary and consistent with the present invention; an administrator of the system may create additional business rules providing for various results based on the analysis of human resources data.

Further, although the above description provides for a supervisor invoking the various processes, such as leave processing, employees in other roles may perform such actions. In one embodiment, the resource management system provides for a role-based access to the system's functions and related data. Thus, for example, a system administrator of the system may assign one or more than one role to a user of the system. Such roles include, but are not limited to, a supervisor, an absence control supervisor, and a manager. Because of the sensitive and confidential nature of the employee data being reviewed, the users corresponding to various roles may be provided different levels of access to the data stored in database 206, for example. In one instance, access to the different sections of the database may be password protected so that various levels of security are implemented.

In another embodiment, employees may access resource management system 202 via telecommunications devices, such as telephones, for requesting leave, reporting a delay in arrival time, or obtaining other information concerning human resources issues, thereby eliminating the need for a manager or supervisor to initiate the leave processing. Employees may access the resource management system to request various types of leave, such as unscheduled personal leave, personal emergency leave (non-FMLA), and/or FMLA leave. Employees may also access the resource management system to notify a supervisor or manager of an anticipated delay in the employee's arrival.

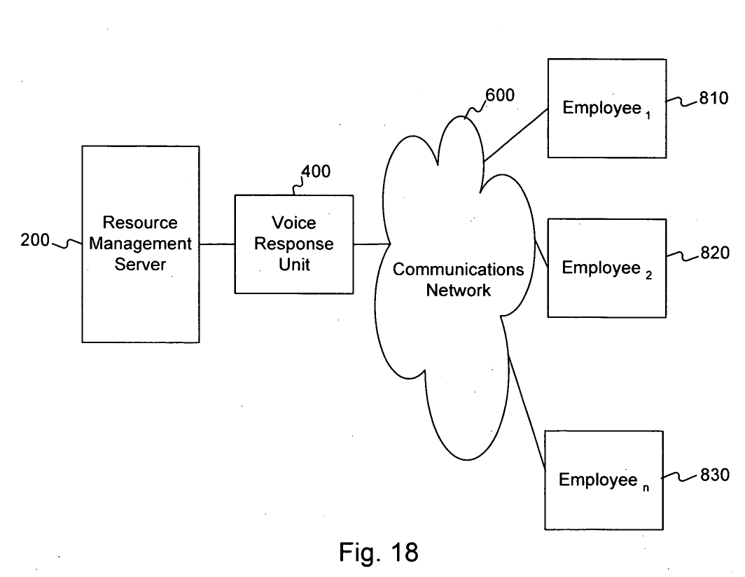

By way of a non-limiting example, FIG. 18 illustrates an exemplary system using which employees may access the resource management system. As shown, resource management server 200 may be coupled to a voice response unit 400, which may further be accessed by employee₁ 810, employee₂ 820, and employeeₙ 830 using a communications network 600. Employees may call a particular telephone number or a similar service to access the resource management server.

Voice response unit 400 may be implemented using, for example, a voice response unit available from Aspect Telecommunications, Corp. of San Jose, Calif. One skilled in the art will appreciate that voice response units made by other manufacturers may be used consistent with the present invention. In addition, call routing and processing may be incorporated into the communications network 600 through the use of call routing software designed to provide such functions. One example is the Geotel software program available from Cisco Systems Inc. of San Jose, Calif.

As indicated above, resource management server communicates with employees 810, 820, . . . 830 through voice response unit 400, which in turn communicates with employees or other users of the system through communications network 600. Communications network 600 may comprise, alone or in any suitable combination, a telephony-based network (such as a PBX or POTS), a local area network (LAN), a wide area network (WAN), a dedicated intranet, and/or the Internet. Further, any suitable combination of wired and/or wireless components and systems may be incorporated into communications network 600.

Although FIG. 18 shows a direct connection between resource management server 200 and voice response unit 400, the communication between these two components may be achieved through the use of a network architecture (not shown) similar to that described above for communications network 600. By using dedicated communication links or shared network architecture, resource management server 200 may be located in the same location or at a geographically distant location from voice response unit 400.

In one embodiment, the voice response unit can be an interactive voice response (IVR) unit which cooperates with the resource management system to provide the employee with self-service communication with the system database. The voice response unit may include a tone and/or speech recognition application, accessible via a telephone number, that will allow employees to self-report leave request such as, for example, for a non-job related illness, injury or unexpected personal emergencies. A separate toll-free telephone number would be provided to accommodate hearing impaired/deaf employees.

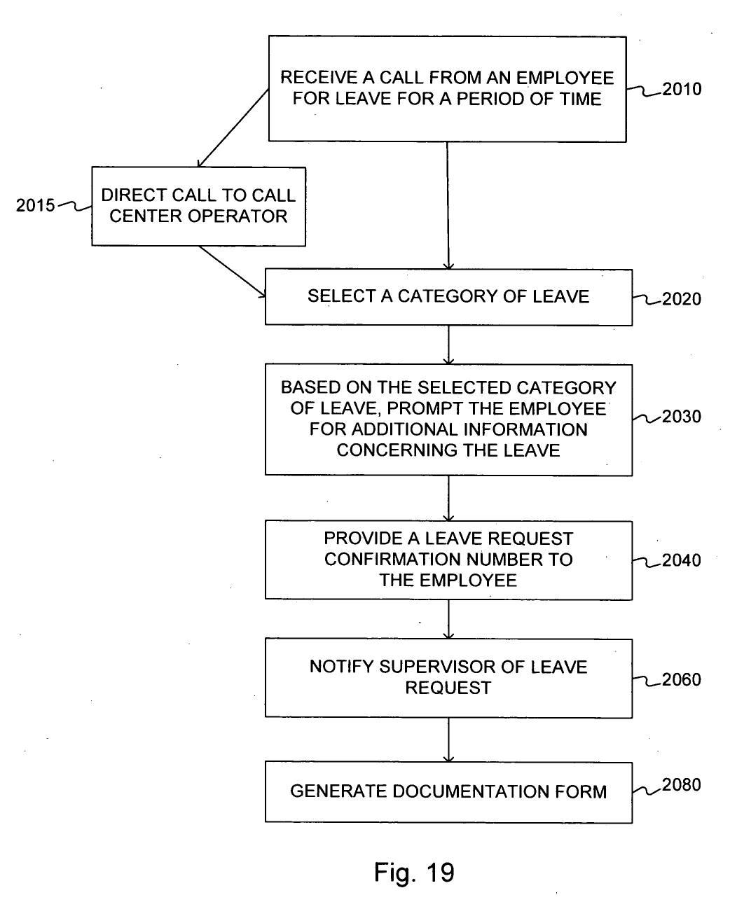

FIG. 19 shows a flow diagram illustrating exemplary call processing for a call for an employee consistent with the present invention. In one embodiment, interactive voice response unit 400 may receive a call from an employee requesting leave for a period of time (step 2010). Next, voice response unit 400, alone or in conjunction with resource management server 200, prompts the employee to select a category of leave (step 2020). Leave categories can include, for example, illness, personal emergency, and community disaster. Based on the selected category of leave, the caller is prompted to provide additional information regarding the leave request (step 2030). For instance, the employee may be prompted to select a leave type. Leave types include, but are not limited to, annual leave, sick leave, and leave without pay. The employee may enter the leave type by saying the leave type (i.e., via voice recognition) or by pressing the appropriate keys on the keypad of the telecommunications device (i.e., via touch tone recognition). Based on the selected leave type, call processing may branch to different paths. By way of a non-limiting example, the prompts for call processing when an employee is unable to work due to his or her illness or injury may vary from exemplary call processing when the employee is unable to work because of personal emergency, and further differ from the prompts to enter information that exist for exemplary call processing when the employee indicates that her absence is for a condition covered by the Family and Medical Act leave.

If the leave request is of a type that does not require special attention or human interaction, the employee may then proceed with the next steps of the call processing as shown in FIG. 19. If, however, the employee is unsuccessful in completing the leave request using the call processing application, the call may be immediately transferred to a centralized call center agent for appropriate handling (step 2015). In either situation, the information related to the leave request will be collected into the system, and a confirmation number for that request issued to the employee. This would enable the employee to receive real-time data for any request processed using the call processing application of the present invention. Thereafter, the supervisor is notified of that request and asked to either approve or deny the request. In one embodiment, the supervisor may receive an electronic message such as an e-mail containing the employee's request. Upon reviewing the email using the resource management system, the supervisor would be asked to indicate an approval or denial of that request through the system.

Voice response unit 400 may also inform the employee that additional documentation is required for approval of the leave. In one embodiment, RMS application 202 may receive input received by voice response unit 400 and then process RMS business rules 204 and/or data stored in database 206 to determine whether additional documentation is required. As part of this step, RMS application 202 may analyze supervisor flagged data to determine an eligibility of the employee for the requested leave. Thus, for example, the supervisor may indicate by inserting data in database 206, based on a suitable reason, that the employee is no longer eligible for a certain type of leave during a particular time-period. RMS application 202 may also analyze employee's leave data stored in database 206 to determine the eligibility of the employee for the requested leave. By way of another non-limiting example, if the employee is requesting a new FMLA case request for this absence, the call processing application would inform the employee that further documentation is necessary. It is contemplated that resource management server 200 and voice response unit 400 are configured such that the actual approval or denial of any request may only be performed by a supervisor for a particular employee, a group of employees, or all of the employees.

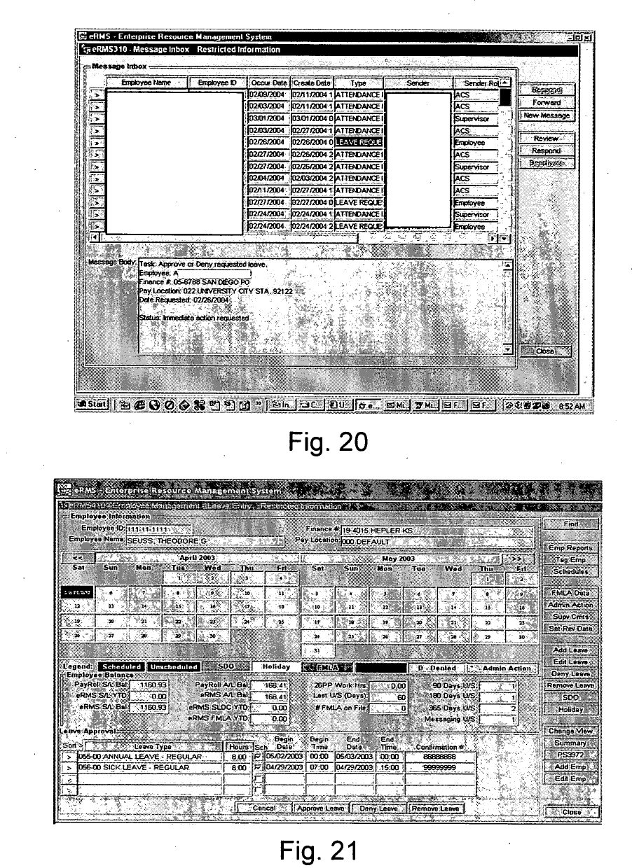

Next, voice response unit provides a leave request confirmation number to the employee (step 2040). Once a confirmation number has been generated, the call processing notifies a supervisor or manager of that employee of the leave request (step 2060). This notification may take several forms. For example, the system may generate an electronic message summarizing the leave request and status (i.e., accepted or denied) if available, and submit that to the supervisor via e-mail, to be received at a user terminal or by a wireless communications device capable of receiving the e-mail. FIG. 20 illustrates an exemplary screen shot that an employer may view once he or she retrieves the electronic leave request message from the employee. Alternatively, or in addition, the system may generate a voice mail message to be sent to the supervisor's voice mail or other telephone message service, with a summary of the leave request and its status for retrieval. The message may request additional information from the employer, such as whether the request is approved, denied or removed. It is contemplated that the leave request message may be sent to several supervisors, and the first supervisor to retrieve or respond to the message would be able to remove the same message from the other supervisors' inboxes.

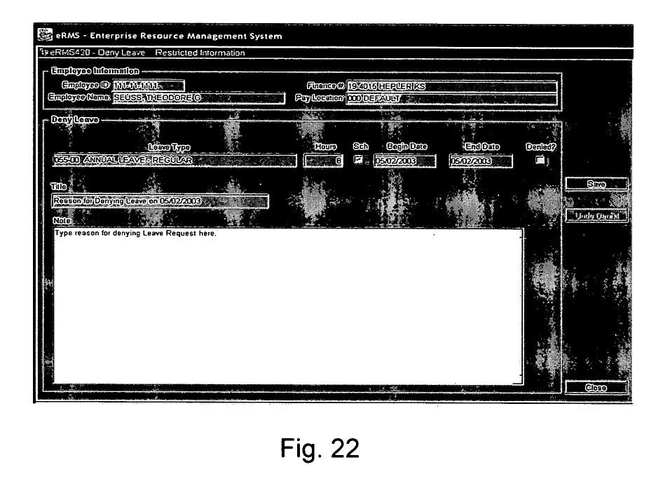

Once the employer responds to the message, either by selecting the appropriate response on a screen of a user terminal, or by pressing the appropriate button on a touch-tone keypad, the response may automatically update that employee's payroll and/or leave record. FIG. 21 illustrates an exemplary screen shot in the system window for an approved leave request, while FIG. 22 illustrates an exemplary screen shot in the system window for a denied leave request, with an area for the supervisor to leave a note for the reason(s) it was denied. In some situations, the employer may elect to place the employee's leave request in a special “hold” category during a specified timeframe until further documentation has been provided. The leave request may or may not be approved prior to it being placed in this category.

In addition, the call processing may also generate a form documenting the leave request for the employee or employer's signature. Upon the issuance of a confirmation number, the resource management system may generate a time and date stamped form summarizing the nature of the leave request and the status of the request, which may then be sent to the employee's e-mail for his signature once the employee returns to the workplace. The executed form may then be submitted to the supervisor or payroll for further processing, so that there is a record of the transaction in case of, for example, a payroll discrepancy or for auditing purposes. Security features may be implemented as previously described so that sensitive employee data remains confidential and consistent with the Privacy Act at every step throughout the call processing.

It is envisioned that this call processing would allow the employee to provide and receive real-time data relating to a leave request, and then communicate that request in real time to his or her immediate supervisor or manager, with employee access to the system available twenty-four hours, seven days a week using a standardized attendance management system. Thus, an employee who experiences an unexpected emergency delay, such as a flat tire or a sick child, and realizes that he or she needs unscheduled leave, may call in the leave request in the manner described. The call processing would then immediately inform the supervisor of the employee's anticipated delay or absence, in a real time manner. One skilled in the art will appreciate that the above call processing is exemplary and additional or alternative call processing may be provided in response to a call from an employee requesting leave.

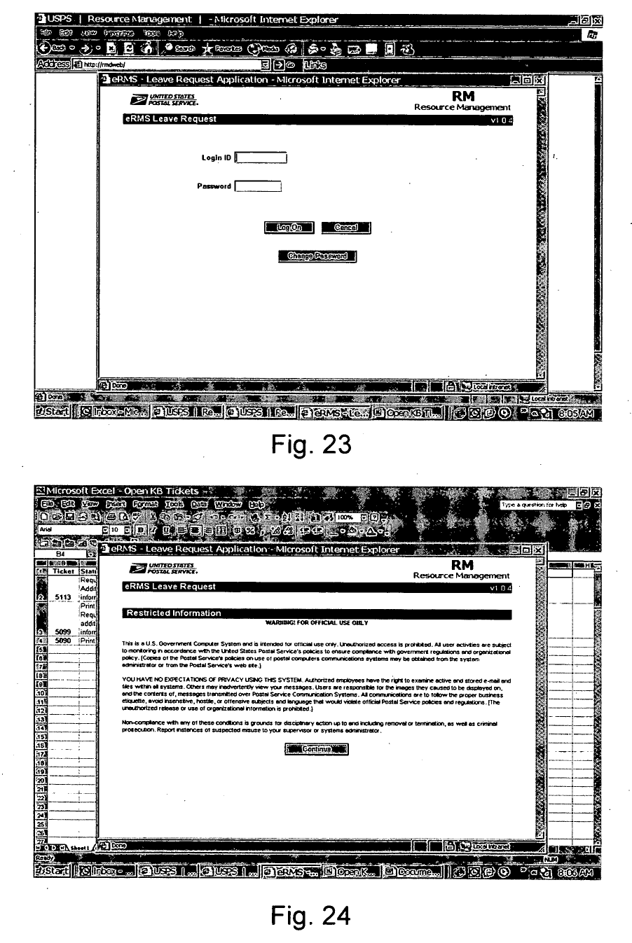

As discussed above, if the leave request is of a type that may require human interaction, or if the employee is unsuccessful in requesting the leave using the call processing application, the employee's call may be immediately transferred to a centralized call center agent. FIGS. 23 through 38 represent a series of screen shots that a call center operator may encounter when receiving an incoming call from an employee requesting leave. The operator may be routed a call from an employee requesting leave when, for example, the interactive call processing application is unsuccessful in processing the request. The sequence of screen shots provide a roadmap by which the operator follows to process the employee's leave request. These screen shots mimic the prompts that an employee hears when he or she uses the call processing features of the present invention. Thus, what is illustrated is also what is heard by an employee using the interactive call processing application.

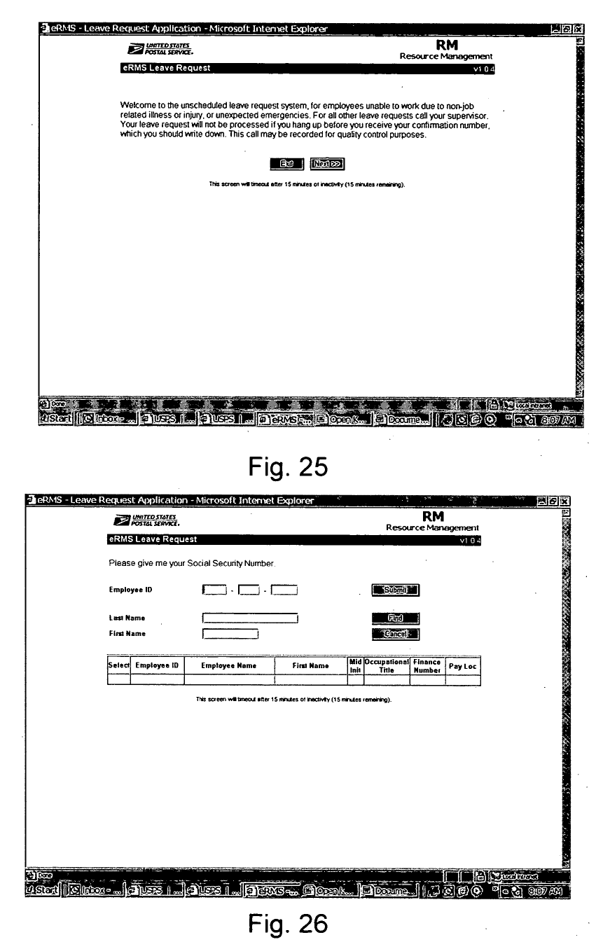

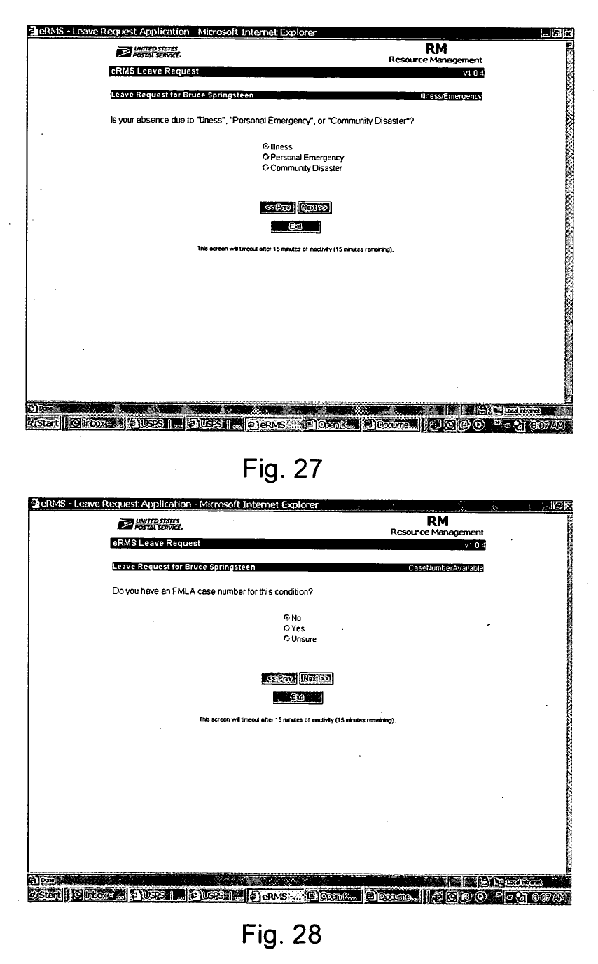

As shown in FIG. 23, the center operator accesses the leave request application of the resource management system of the present invention by entering his or her login ID and password. Upon entering the leave request application, a warning is displayed (shown in FIG. 24) and acknowledgment of the restrictions must first be made by selecting “Continue” before proceeding. A welcome message, as shown in FIG. 25, next appears. It is contemplated that the language contained in the welcome screen will be read to the employee. Next, as shown in FIG. 26, the employee is asked for his or her employee ID, which may be his or her social security number. Alternatively, if the employee does not know his or her employee ID, the operator may look up the ID number using the caller's first and last name. After the operator has selected the correct employee, the caller is asked to select a category of leave in FIG. 27. The categories of leave include sick leave or illness, personal emergency, or community disaster.

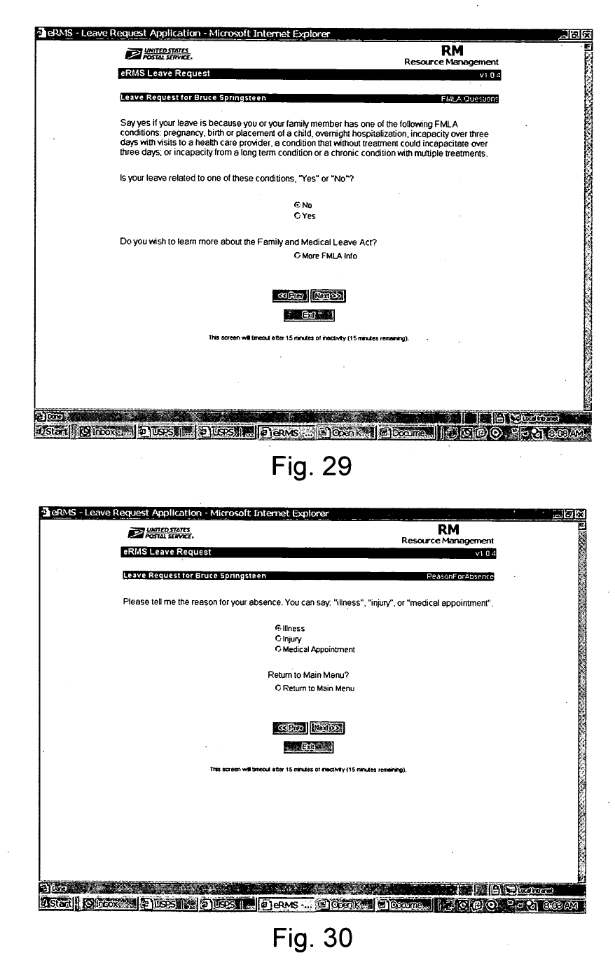

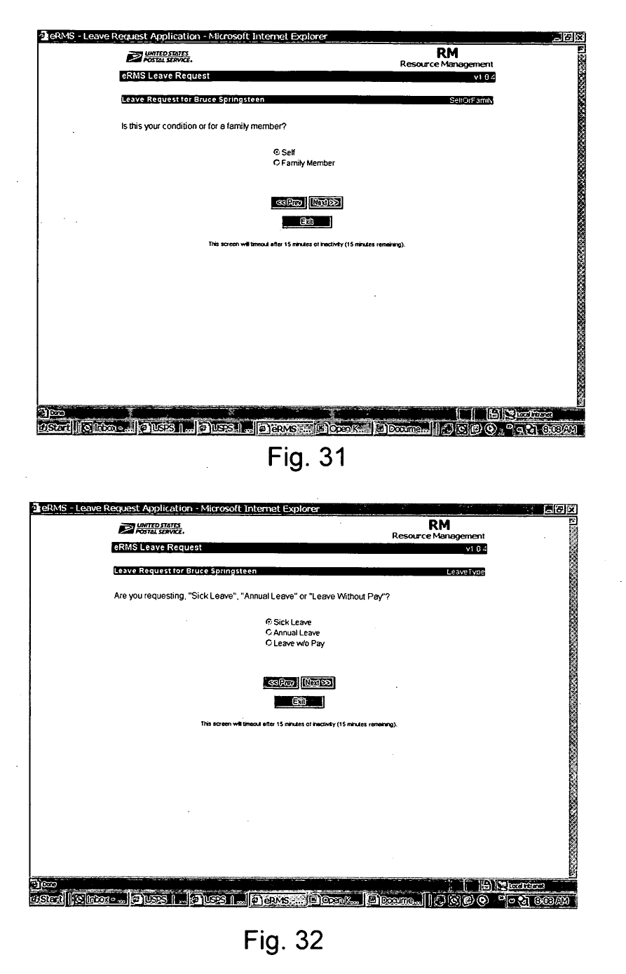

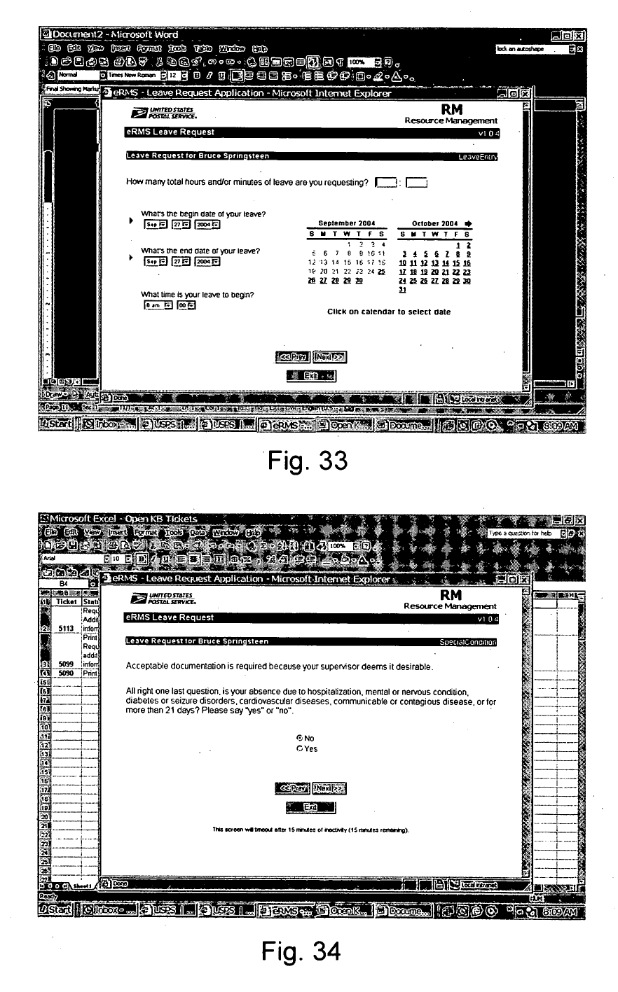

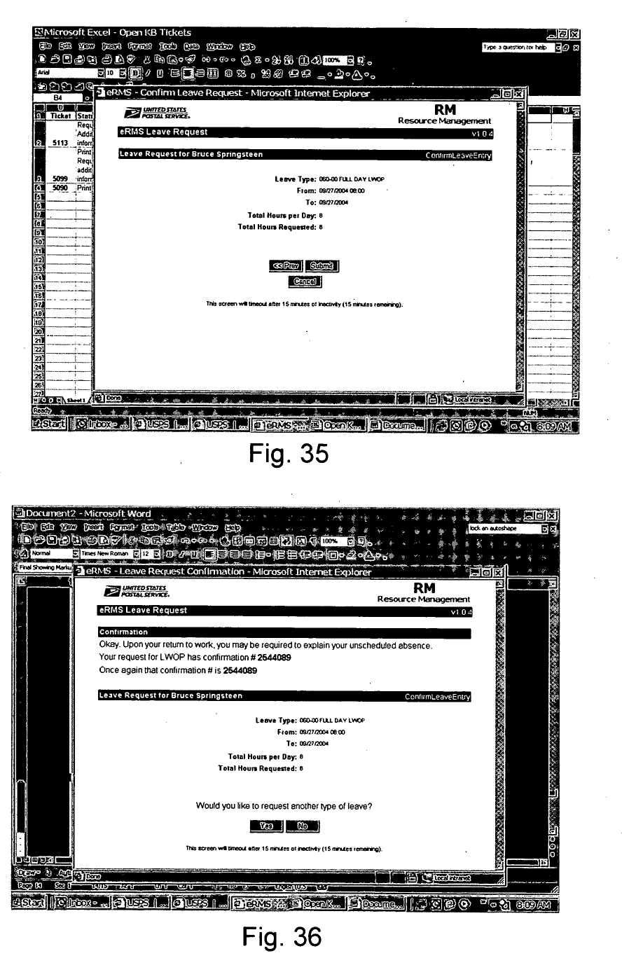

If the “Illness” category is selected, the employee is then asked if he or she has an FMLA case number for this request or condition, as shown in FIG. 28. If there is an FMLA number, then the employee is asked for further information regarding the conditions of the leave, as shown in FIG. 29. If there is no FMLA number, or if the leave is not FMLA related, then the employee is asked to select the reason for the absence (as shown in FIG. 30) and whether the illness or injury belongs to himself or herself, or a family member (as shown in FIG. 31). The employee is then asked to select which type of leave is being requested. As shown in FIG. 32, the types of leave can include sick leave, annual leave, and leave without pay, for example. Next, the employee is asked for the start and stop dates of the leave, and/or start and stop times for the leave, if applicable (as shown in FIG. 33). If required, further information may be requested from the employee (as shown in FIG. 34). For example, the employee may be asked to provide documentation upon his or her return to work. The employee may also be asked to confirm that the leave request information provided to the call center operator is correct (as shown in FIG. 35. Finally, a confirmation number is issued to the employee, as shown in FIG. 36, which indicates that the leave request has been processed through the resource management system of the present invention.

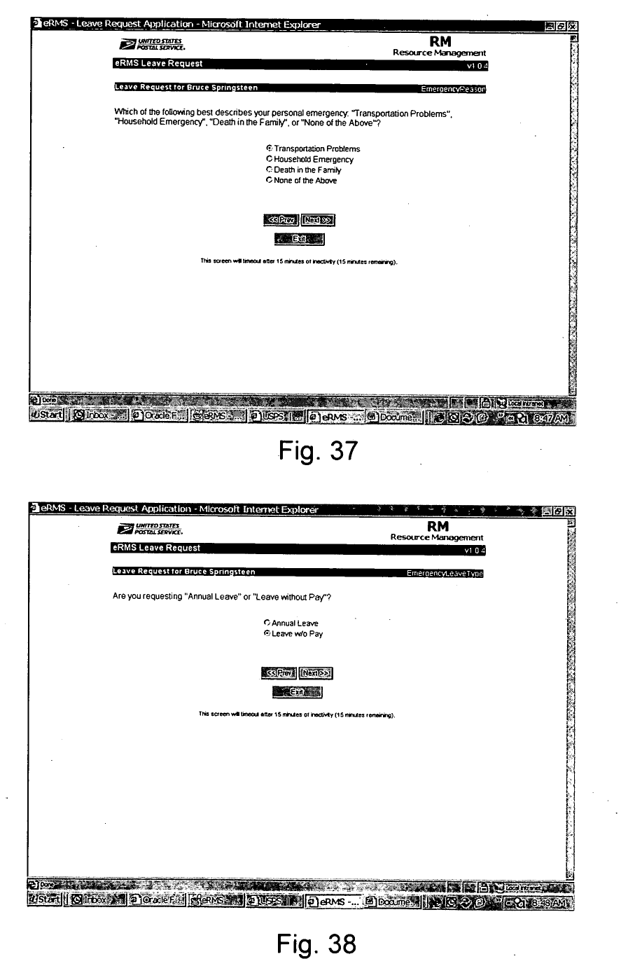

In the alternative, if the employee selects “Personal Emergency” as the category of leave, rather than FIGS. 28 through 32, the call center operator would instead see FIGS. 37 and 38. In this case, the employee would be asked for additional information related to the personal emergency, such as for example, whether the leave request is due to a transportation problem, household emergency, death in the family, or other condition (as shown in FIG. 37). Next, the employee must select a leave type as shown in FIG. 38. Thereafter, screens similar to those shown in FIGS. 33 through 36 will appear. If the employee selects “Community Disaster” as the category of leave, the employee will be warned to exercise reasonable care and diligence to report to work and asked to select a leave type (e.g., snow, fire, flood, or civil disorder) similar to what is shown in FIG. 37. FIGS. 28 through 32 would not appear, while screens similar to FIGS. 33 through 36 would appear immediately after a screen similar to FIG. 37 in such a scenario.

Also provided with the resource management system is a web-based application of the call-processing features of the present invention. The web-based application adheres to the same functions as described and illustrated in FIGS. 18 and 19, and is accessible via an intranet or Internet. A web-based tutorial for the training, deployment, and preparation of users of the systems and methods consistent with the present invention is also provided. This web-based tutorial provides step-by-step instructions and examples for both employees and employers (i.e., supervisors, managers, directors, etc.) to walk the user through the resource management system of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for managing human resources, the method comprising:
applying at least one business rule to human resources management data; and
automatically triggering at least one action based on a result of the application of the at least one business rule to the human resources management data.

2. The method of claim 1, wherein the human resources management data comprises at least one of employee leave data, employee schedule data, and employee administrative action data.

3. The method of claim 1, wherein the employee leave data further comprises annual leave data, annual medical leave data, and annual family leave data.

4. The method of claim 1, wherein the at least one action is a request for additional information.

5. The method of claim 1, wherein the at least one action is an approval based on a compliance with the at least one business rule.

6. The method of claim 1, wherein the at least one action is a denial based on a violation of the at least one business rule.

7. A system for managing human resources, the system comprising:
means for applying at least one business rule to human resources management data; and
means for automatically triggering at least one action based on a result of the application of the at least one business rule to the human resources management data.

8. A method for providing interactive leave processing, the method comprising:
receiving a call from an employee to request leave for a period of time;
prompting the employee to select a category of leave;
based on the selected category of leave, prompting the employee for additional information concerning the leave; and
providing a leave request confirmation number to the employee.

9. The method of claim 8, further comprising informing the employee that additional documentation is required for approval of the leave.

10. The method of claim 8, further comprising approving the leave.

11. The method of claim 8, further comprising denying the leave.

12. The method of claim 11, further comprising providing a reason for the denial of the leave to the employee.

13. The method of claim 8, further comprising analyzing supervisor flagged data to determine an eligibility of the employee for the leave.

14. The method of claim 8, further comprising analyzing employee leave data to determine an eligibility of the employee for the leave.

15. The method of claim 8, further comprising communicating the request to the employer.

16. The method of claim 8, further comprising generating an authorization form documenting the request for leave.

17. The method of claim 8, wherein the category of leave is selected from the group consisting of illness, personal emergency, and community disaster.

18. The method of claim 8, wherein the additional information relates to at least one of a leave type, a personal health condition, a non-job-related condition, and a family medical leave condition.

19. The method of claim 8, wherein the category of leave is selected using a voice recognition application.

20. The method of claim 8, wherein the category of leave is selected using a touch tone recognition application.

21. The method of claim 18, wherein the leave type is selected from the group consisting of annual leave, sick leave, and leave without pay.
